(19) United States
(12) Patent Application Publication
(10) Pub. No.: US 2019/0010794 A1
(43) Pub. Date: Jan. 10, 2019

(54) JUNCTION STRUCTURED MATERIALS AS PROPPANT ANTI-SETTLING AGENTS

(71) Applicant: Baker Hughes, a GE company, LLC, Houston, TX (US)

(72) Inventors: James B. Crews, Willis, TX (US); Naima Bestaoui-Spurr, The Woodlands, TX (US)

(73) Assignee: Baker Hughes, a GE company, LLC, Houston, TX (US)

(21) Appl. No.: 16/123,687

(22) Filed: Sep. 6, 2018

Related U.S. Application Data
(63) Continuation-in-part of application No. 15/921,388, filed on Mar. 14, 2018.
Application No. 15/921,388 is a continuation-in-part of application No. 16/068,776, filed on Jul. 9, 2018.
(60) Provisional application No. 62/554,649, filed on Sep. 6, 2017.
(60) Provisional application No. 62/471,435, filed on Mar. 15, 2017.
(60) Provisional application No. 62/367,269, filed on Jul. 27, 2016.

(51) Int. Cl. E21B 43/267; C09K 8/80

(52) U.S. Cl. CPC E21B 43/267; C09K 2208/08; C09K 8/80

(57) ABSTRACT

A method for using junction-structured materials that may be introduced into a hydraulic fracture of a subterranean formation for suspending proppants therein and inhibiting or preventing the proppant from settling by gravity within the fractures, the method involving hydraulically fracturing the subterranean formation to form fractures in the formation; during and/or after hydraulically fracturing the subterranean formation, introducing a plurality of junction-structured materials into the fractures, wherein the materials comprise one or more primary stems from which a plurality of primary barbs extend; and collecting or settling the proppants upon the materials as the materials contact opposing walls of the fractures thereby inhibiting or preventing the proppant from settling by gravity. The materials may also be introduced into the formation as part of a fluid composition.

### CROSS-REFERENCE TO RELATED APPLICATION

This application claims the benefit of U.S. Provisional Patent Application Ser. No. 62/554,649 filed Sep. 6, 2017, which is incorporated herein by reference in its entirety. This application is also a Continuation-in-Part of U.S. application Ser. No. 15/921,388 filed Mar. 14, 2018 and U.S. application Ser. No. 16/068,776 filed Jul. 9, 2018.

### TECHNICAL FIELD

The present invention relates to methods, fluids, and materials for inhibiting or preventing proppants from settling within a hydraulic fracture formed in a subterranean formation; and more particularly relates to the use of junction-structured materials for inhibiting or preventing proppants from settling within a hydraulic fracture, which materials can be readily pumped into the fracture to interact with the proppants to prevent them from settling.

### TECHNICAL BACKGROUND

Hydraulic fracturing is the fracturing of subterranean rock by a pressurized liquid, which is typically water mixed with a proppant (often sand) and chemicals. The fracturing fluid is injected at high pressure into a wellbore to create, in shale for example, a network of fractures in the deep rock formations to allow hydrocarbons to migrate to the well. When the hydraulic pressure is removed from the well, the proppants, e.g. sand, aluminum oxide, etc., hold open the fractures once fracture closure occurs. In one non-limiting embodiment chemicals are added to increase the fluid flow and reduce friction to give “slickwater” which may be used as a lower-friction-pressure placement fluid. Alternatively in different non-restricting versions, the viscosity of the fracturing fluid is increased by the addition of polymers, such as crosslinked or uncrosslinked polysaccharides (e.g. guar gum) or by the addition of viscoelastic surfactants (VES). The thickened or gelled fluid helps keep the proppants within the fluid.

Recently the combination of directional drilling and hydraulic fracturing has made it economically possible to produce oil and gas from new and previously unexploited ultra-low permeability hydrocarbon bearing lithologies (such as shale) by placing the wellbore laterally so that more of the wellbore, and the series of hydraulic fracturing networks extending therefrom, is present in the production zone permitting production of more hydrocarbons as compared with a vertically oriented well that occupies a relatively small amount of the production zone; see FIGS. 1A and 1B. “Laterally” is defined herein as a deviated wellbore away from a more conventional vertical wellbore by directional drilling so that the wellbore can follow the oil-bearing strata that are oriented in a non-vertical plane or configuration. In one non-limiting embodiment, a lateral wellbore is any non-vertical wellbore. It will be understood that all wellbores begin with a vertically directed hole into the earth, which is then deviated from vertical by directional drilling such as by using whipstocks, downhole motors and the like. A wellbore that begins vertically and then is diverted into a generally horizontal direction may be said to have a “heel” at the curve or turn where the wellbore changes direction and a “toe” where the wellbore terminates at the end of the lateral or deviated wellbore portion. In one non-limiting embodiment, the “sweet-spot” of the hydrocarbon bearing reservoir is an informal term for a desirable target location or area within an unconventional reservoir or play that represents the best production or potential production. The combination of directional drilling and hydraulic fracturing has led to the so-called “fracking boom” of rapidly expanding oil and gas extraction in the US beginning in about 2003.

Most fractures have a vertical orientation as shown schematically in FIG. 1A which illustrates a wellbore 10 having with a vertical portion 12 and a lateral portion 14 drilled into a subterranean formation 16. Through hydraulic fracturing a fracture 28 having an upper fracture 18 and a lower fracture 20 have been created where there is fluid communication between upper and lower fractures 18 and 20, and proppant 22 is shown uniformly or homogeneously distributed in the fracturing fluid 24 of the upper and lower fractures 18 and 20. However, over long fracture closure times, and as the viscosity of the fracturing fluid decreases after fracturing treatments, the proppants 22 settles in the lower fracture 20 and the upper fracture 18 closes without proppant 22 to keep it open, thus operators lose the upper fracture 18 conductivity as schematically illustrated in FIG. 1B. The upper fracture 18 may be the location of the sweet spot horizon 26 of the shale play of the formation 16. The sweet-spot horizon 26 is defined herein as the horizon with in the shale interval to be hydraulically fractured that will produce the most hydrocarbon compared to the shale horizons hydraulically fractured directly above and below.

Efforts have been made to make the proppant pack within a fracture more uniform. U.S. Pat. No. 9,010,424 to G. Agrawal, et al. and assigned to Baker Hughes Incorporated involves disintegrative particles designed to be blended with and pumped with typical proppant materials, e.g. sand, ceramics, bauxite, etc., into the fractures of a subterranean formation to prop them open. With time and/or change in wellbore or environmental condition, these particles will either disintegrate partially or completely, in non-limiting examples, by contact with downhole fracturing fluid, formation water, or a stimulation fluid such as an acid or brine. Once disintegrated, the proppant pack within the fractures will lead to greater open space enabling higher conductivity and flow rates. The disintegrative particles may be made by compacting and/or sintering metal powder particles, for instance magnesium or other reactive metal or their alloys. Alternatively, particles coated with compacted and/or sintered nanometer-sized or micrometer sized coatings could also be designed where the coatings disintegrate faster or slower than the core in a changed downhole environment.

However, there is still a desire for improved methods and materials for maintaining conductivity of the proppants and reduce settling of proppants in reservoirs where closure may take days to weeks to increase and maintain the permeability a proppant pack within a hydraulic fracture for better production of hydrocarbons from the subterranean formation.

### SUMMARY

There is provided in one non-restrictive version, a method of suspending proppants in a hydraulic fracture of a subterranean formation, where the method involves hydraulically fracturing the subterranean formation to form fractures in the formation; during and/or after hydraulically fracturing the subterranean formation, introducing proppants into the fractures; during and/or after hydraulically fracturing the subterranean formation, introducing a plurality of junction-structured materials into the fractures, wherein the materials comprise one or more primary stems from which a plurality of primary barbs extend; and collecting or settling the proppants upon the materials as the materials contact opposing walls of the fractures thereby inhibiting or preventing the proppant from settling by gravity.

There is additionally provided in another non-limiting embodiment, a fluid composition for suspending proppants in a hydraulic fracture of a subterranean formation, where the fluid includes a carrier fluid, a plurality of junction-structured materials comprising one or more primary stems from which a plurality of primary barbs extend, and a plurality of proppants.

### BRIEF DESCRIPTION OF THE DRAWINGS

FIG. 1A is a schematic illustration of a wellbore with an upper and lower fracture depicting proppant uniformly distributed in a fracturing fluid in the upper and lower fracture, which is under hydraulic pressure to keep it open;

FIG. 1B is a schematic illustration of a wellbore with an upper and lower fracture depicting proppant having settled to the bottom of the lower fracture, the upper and lower fractures having closed, where the upper fracture is substantially completely closed due to the lack of proppant therein;

FIG. 2 is a photographic illustration of a naturally-occurring junction-structured material in the form of a feather having an array of barbs and barbules that may be used in the methods and fluids described herein;

FIG. 3 is a photographic illustration of a strand of eyelashes, another example of a junction-structured material that may be used in the methods and fluids described herein;

FIG. 4 is a schematic illustration of a man-made junction-structured material having barbules that may be used in the methods and fluids described herein;

FIG. 5 is a photographic illustration of a non-limiting embodiment of a man-made junction-structured material having a network of barbs and barbules extending from one or more stems that may be used in the methods and fluids described herein;

FIG. 6 is a schematic illustration of yet another example for a man-made junction-structured material having parallel primary stems from which alternating barbs extend that may be used in the methods and fluids described herein;

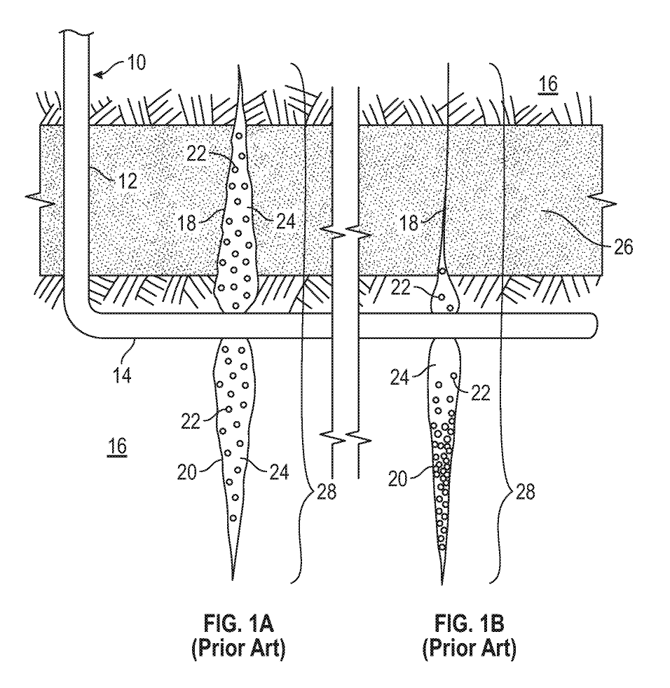

It will be appreciated that the drawings are not to scale and that certain features have been exaggerated for illustration or clarity.

### DETAILED DESCRIPTION

It has been discovered that junction-structured materials may be transported, with or without proppants, into a hydraulic fracture during and/or after hydraulically fracturing a subterranean formation to catch, lodge, hold, snag, wedge and otherwise engage proppants and temporarily hold or suspend them in place within the fracture so that when pumping has been completed, the fracture faces close against relatively uniformly distributed proppant placement to provide an improved permeability proppant pack in the fracture, to maintain vertical conductivity of the proppant, and to prevent the proppant from settling to the bottom of the hydraulic fracture during long fracture closure times.

In suitable, non-limiting embodiment, such materials are composed of man-made or naturally-occurring materials and comprise one or more primary stems from which a plurality of primary barbs extend. In a non-restrictive embodiment, the primary barbs may comprise a plurality of secondary barbs or a plurality of smaller barbules extending or projecting therefrom, wherein the secondary barbs and the barbules that may extend or project from the primary barbs may be straight or wavy.

The materials are configured in such a way that to be able to connect with and engage each other, the fracture face(s), and proppant(s). Thus, there is may be wide variety of configurations and shapes of these materials. It will be appreciated that while the materials may be at least initially configured to have a generally flat structure and/or small cross-sectional profile to permit them to be pumped downhole to be introduced into hydraulic fracture making them nearly two-dimensional, the materials may also have a fuller three-dimensional (3D) structure. Suitable examples of junction-structured materials that may be used include, but are not limited to, naturally-occurring feathers or strand of eyelashes, or a variety of three-dimensional or almost two-dimensional structures of man-made materials in the shape of a feather, a strand of eyelashes, a comb, or the like.

The materials are all functional or functionalized, to have at least two functions or abilities: (1) they must be transportable with a fluid (defined herein as a liquid or gas) downhole to a subterranean formation and a hydraulic fracture within the subterranean formation. They may be part of, contained in, suspended in, dispersed in, and otherwise comprised by the fracturing fluid that fractures the formation. Alternatively they may be introduced subsequently to formation of the hydraulic fracture in a subsequent fluid. Additionally the materials must have (2) the function or ability to interact with the fracture face (fractured face of the formation) such as by dragging, skidding, snagging, catching, lodging, poking, wedging or otherwise engaging the sides of the fracture while also snagging, catching, holding, lodging, wedging, supporting, and otherwise engaging the proppant, which is also in the fluid, thereby holding the proppant in place relative to the fracture face to inhibit and/or prevent and/or be a localized support location for the proppant from settling into the lower portion of the fracture by gravity. In one non-limiting embodiment a localized support location is defined to mean as in a concentration distribution of every 2 inches, or every 4 inches, or even up to every 10 inches apart from each other. The junction-structured material pieces will be localized in positions where proppant that begins to settle will only settle so far until they reach a material position where the proppant will come to rest upon and not settle any further. Thus the material is a localized support location that can vary in distances a part from each other.

The junction-structured materials are designed and configured to have a geometry and a composition to interact with fracture walls once treatment is completed, that is, when the treatment pumps are stopped and treatment fluid flow into hydraulic fractures ceases. The functional design of the materials configures them to interact with the fracture walls to create distributed support structures within the hydraulic fracture where each material will physically collect settling proppant particles at each material location. In one non-limiting embodiment, junction-structured materials in this case means many distributed anti-settling agents configured to act as support structures, where “support structure” means a physical object to obstruct, prevent, restrict, and otherwise control proppant from settling to the bottom of the hydraulic fracture by gravity. In one non-limiting embodiment the fractures are oriented vertically, or to a vertical degree i.e. where proppant settling by gravity is undesirable.

It will be appreciated that it is not necessary for the material to hold the proppant fast to the fracture face in the sense of adhering it or fixing it in place. When the fracture closes on the proppant, that is the force and process that holds the proppant in a fixed place and location. The material only needs to catch, snag, hold, and/or support the proppant sufficiently to inhibit or prevent it from settling by gravity. It is acceptable if the material holds the proppant fast to the fracture face, but it is not necessary because it is expected that as the fracture closes and the space between the opposing fracture walls narrows the proppants may be moved slightly into their permanent places under closure pressure. In other words, the proppants may be temporary suspended for a time before the fracture closes long enough for their motion downward is inhibited or prevented from settling in the bottom of the fracture. Thus the materials must be transportable in a treatment fluid, but also have a physical shape or combination with physical property that interacts with formation face (drag, skid, snag, catch, poke, wedge, etc.), and/or interaction in a fracture network, such as at complex fracture junctions, narrowings of hydraulic fracture, and of course the ultimate property of residing or fixating in the fracture locale once treatment pumping has been completed and be able to suspend and support proppant particles.

It should also be appreciated that while a single piece of junction-structured material may be very capable of holding one proppant in place, it is expected that multiple or a plurality of materials will also catch, snag, collect, and otherwise engage with one another to support and catch one or more proppant to inhibit and/or prevent the proppant from settling due to gravity.

The materials may be composed of a naturally-occurring material, such as in the form of feather(s) or eyelash hair, or composed of a man-made materials including, but not necessary limited to cotton, wool, silk, fiberglass, polyester, polyurethane, aramid, acrylic, nylon, polyethylene, polypropylene, polyamide, a polycarbonate, a polyvinyl alcohol, polyactic acid, polyglycolic acid, cellulose, polylactide, polyethylene terephthalate, rayon, other synthetic fibers, metals such as alumina or copper, metal oxides such as aluminum oxides, stainless steel or any other inorganic or organic/inorganic material and the like, and combinations thereof. The materials may be flexible or rigid. Material properties to be considered include, but are not necessarily limited to, density, diameter, length, stiffness, surface roughness, linear character (straight, curled, kinked, etc.), solubility, melt temperature, softening temperature, flexibility with heating, etc., although it is not necessary for all of these properties to be considered. Downhole temperatures may vary from about 38° C. to about 205° C., and thus the materials need to function at these temperatures. Other characteristics and properties to consider include, but are not necessarily limited to, stiffness, density, geometric design and, longevity in the expected hydraulic fracture conditions, solubility, dispersibilty (in water, salt water, etc.), transportability (in polymer-viscosified fluid, in viscoelastic surfactant-viscosified fluids, and in non-viscous (water and slickwater) treatment fluids), and whether the materials are hydrophilic or hydrophobic, and combinations of these.

In another non-limiting embodiment at least a portion of the material is hydrolysable before or after the inhibiting or preventing the proppant from settling. “Hydrolyzable” as defined herein is synonymous with dissolvable. Generally, it is expected that the hydrolysis will be achieved by water alone, which includes water and the temperature necessary for overcoming the activation energy required for hydrolysis. Hydrolysis may also be accomplished by water having an acidic or alkaline agent in water in a proportion suitable and/or a pH suitable to dissolve or decompose part or all of the materials. “Decompose” is defined herein to mean that the disintegration may not generate water soluble chemicals; that is, there may be insoluble portions or pieces remaining. It should be appreciated that the material and/or threads do not need to be hydrolyzable or dissolvable, but may be from common, relatively inexpensive materials that may decompose very slowly, such as over the course of many years. Suitable hydrolysable materials include, but are not necessarily limited to, polyvinyl alcohols (PVOH), polylactic acids (PLA), polyglycolic acid (PGA), polyethylene terephthalate (PET), polyesters, polyamides, polycarbonates, and combinations thereof, that at least partially dissolves in water. These materials will be discussed in further detail below.

In one non-limiting embodiment at least a portion of the materials introduced into the fractures is hydrolyzable, meaning that of multiple types of materials introduced, some materials are hydrolyzable, or relatively more hydrolyzable than others. Alternatively, or additionally, in another non-restrictive version, at least a portion of each material is hydrolysable.

With respect to the dimensions of the materials, the materials can be long or short. it will be understood that the fractures each have at least two opposing fracture walls across a gap and where the material singly has at least one dimension that spans the gap between the opposing fracture walls or where multiple materials interconnected or entangled with one another spans the gap between the opposing fracture walls. In one non-limiting embodiment the materials comprise an average length of from about 0.1 inch independently to about 20 inches (about 0.25 to about 51 cm), alternatively from about 1.5 inch independently to about 15 inches (about 3.8 to about 38 cm), and in another non-limiting embodiment from about 2 inch independently to about 12 inches (about 5.1 to about 31 cm). The term “independently” as used with respect to a range means that any lower threshold may be combined with any upper threshold to give a suitable alternate range. As an example, a suitable alternative average material length range would be from about 1.5 inch to about 15 inches.

The junction-structured materials may be thin or thick and may have an average width of from about 0.05 inch independently to about 8 inch (about 1.3 mm to about 20 cm), alternatively from about 0.1 inch independently to about 4 inch (about 2.5 mm to about 10 cm), and in another non-limiting embodiment from about 0.2 inch independently to about 2 inch (about 5 mm to about 5.1 cm). The materials may have an average thickness of from about 0.002 inch independently to about 0.2 inch (about 0.05 mm to about 5 mm), alternatively from about 0.004 inch independently to about 0.16 inch (about 0.1 mm to about 4 mm), and in another non-limiting embodiment from about 0.008 inch independently to about 0.08 inch (about 0.2 mm to about 2 mm).

In one non-limiting embodiment a minimum aspect ratio for the material is about 5 to 1 to 0.5 with a maximum aspect ratio of 10000.

In an alternative embodiment, the materials may be transported or loaded via a carrier fluid along with the proppant, such as the treatment fluid, fracturing fluid or other carrier fluid, which may be water, brine, crosslinked or not crosslinked fluid, linear gel fluid, VES fluid or any other fluid used in fracturing operations. The loading or proportion of the materials in the treatment fluid, fracturing fluid, or other carrier fluid may range from about 0.1 pounds per thousand gallons (pptg) independently to about 200 pptg (about 0.01 to about 24 kg/m³); from about 0.2 pptg independently to about 100 pptg (about 0.02 to about 12 kg/m³); from about 0.5 pptg independently to about 50 pptg (about 0.06 to about 6 kg/m³).

The present invention will be explained in further detail in the following non-limiting examples that are provided only to additionally illustrate the invention but not narrow the scope thereof.

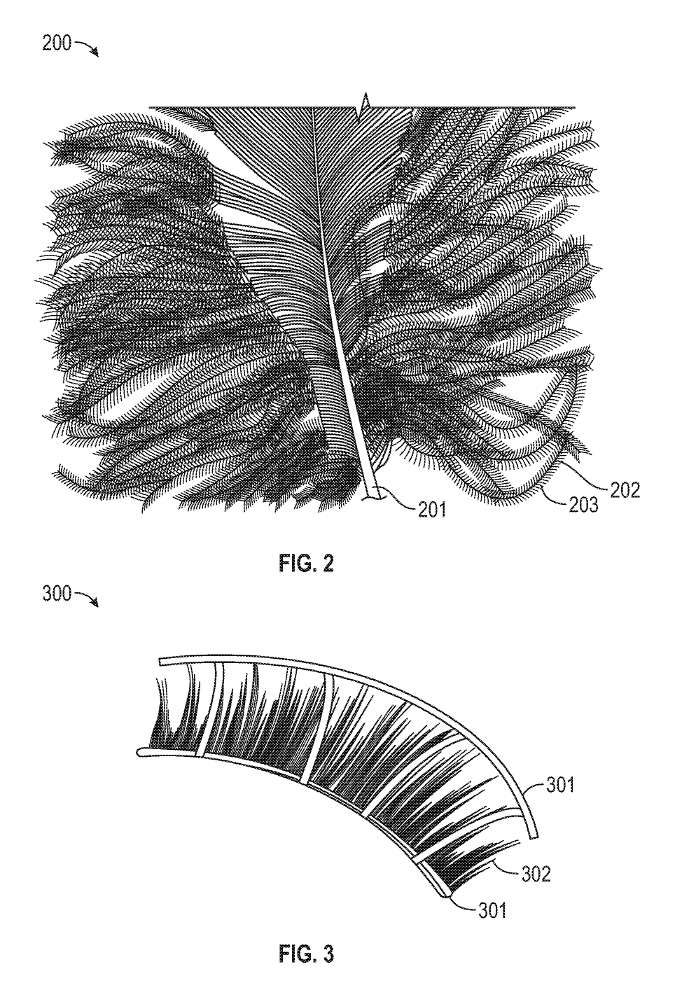

Shown in FIG. 2 is a photographic representation of one non-limiting embodiment of a naturally-occurring junction-structured material. FIG. 2 depicts a feather 200 having a primary stem 201 and an array of barbs 202 and barbules 203. In operation, the barbs and barbules of the feathers may interact with the fracture walls when settling into the fracture or floating up through the fracture (depending on the weight and/or specific gravity of the feathers), and wedge or lodge in the hydraulic fracture via the barbs/barbules-fracture wall interaction. From that point, the proppants can settle and collect upon the lodged feathers, potentially stopping proppant gravimetric settling, creating a distribution of proppant collections on feathers from top to bottom and lengthwise in the hydraulic fracture, and preventing the proppant from settle to bottom of hydraulic fracture during long fracture closure time completion practice

FIG. 3 displays a photograph of a strand of eyelashes 300 having one or more primary stems 301 and a series of primary barbs 302 extending from one or more primary stems as another example of a junction-structured material that may be used in the methods and fluids described herein. The strand of eyelashes may be made up of naturally-occurring materials or man-made materials and may function similarly within the fracture as the junction-structured material in the shape of a feather shown in FIG. 2 and discussed in the previous paragraph.

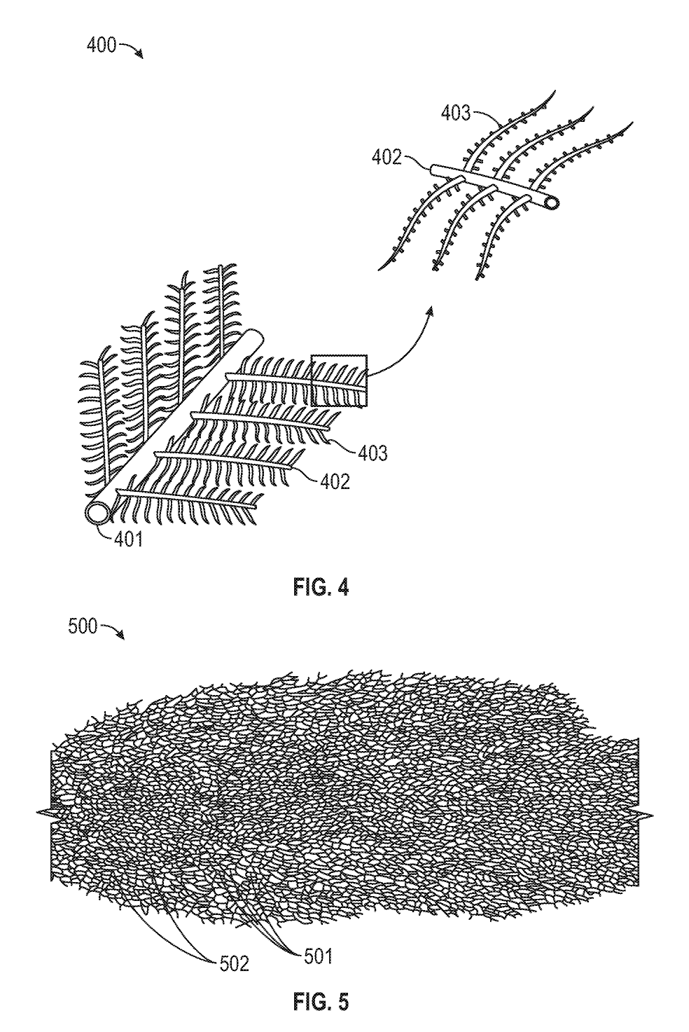

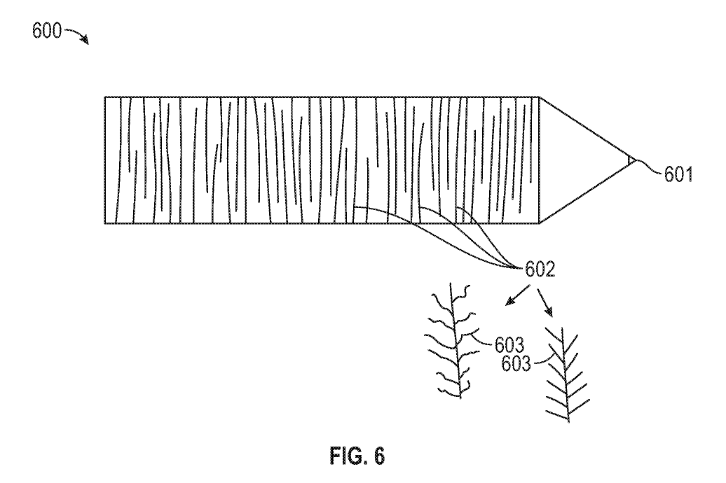

Shown in FIGS. 4 and 5 are other embodiments of suitable man-made junction-structured materials for use as proppant anti-settling agents. The material 400 in FIG. 4 comprises a primary stem 401 with a plurality of primary barbs 402 from which a plurality of smaller barbules (i.e. hooklets) 403 extend. Whereas, FIG. 5 displays a synthetic junction-structured material 500 having a network of primary barbs 501 extending from multiple primary stems 502.

FIG. 6 illustrates yet another, non-restrictive embodiment of a man-made junction-structured material 600 having a pair parallel primary stems 601 from which multiple alternating primary barbs 602 extend. As shown in the figure, the primary alternating barbs may comprise barbules 603 extending from both sides of the primary barb. The barbules are shown to be either wavy or straight. As with the other junction structured materials described, the material shown in FIG. 6 still allow control of the density of proppant packing.

In the foregoing specification, the invention has been described with reference to specific embodiments thereof, and has been described as effective in providing methods and compositions for using materials to inhibit or prevent the settling of proppants in fractures. However, it will be evident that various modifications and changes can be made thereto without departing from the broader scope of the invention as set forth in the appended claims. Accordingly, the specification is to be regarded in an illustrative rather than a restrictive sense. For example, specific combinations of junction-structured materials; primary stems; barbs; barbules; polymers; functional structures; proppants; treatment, fracturing and other carrier fluids; brines; acids; dimensions; proportions; aspect ratios; materials; and other components falling within the claimed elements and parameters, but not specifically identified or tried in a particular method or composition, are anticipated to be within the scope of this invention. Similarly, it is expected that the methods may be successfully practiced using different sequences, loadings, pHs, compositions, structures, temperature ranges, and proportions than those described or exemplified herein.

The words “comprising” and “comprises” as used throughout the claims is interpreted to mean “including but not limited to”.

The present invention may suitably comprise, consist of or consist essentially of the elements disclosed and may be practiced in the absence of an element not disclosed. For instance, there may be provided a method of suspending proppants in a hydraulic fracture of a subterranean formation, where the method consists essentially of or consists of: hydraulically fracturing the subterranean formation to form fractures in the formation; during and/or after hydraulically fracturing the subterranean formation, introducing a plurality of junction-structured materials into the fractures, wherein the materials comprise one or more primary stems from which a plurality of primary barbs extend; and collecting or settling the proppants upon the materials as the materials contact opposing walls of the fractures thereby inhibiting or preventing the proppant from settling by gravity.

In another non-limiting embodiment, there may be provided a fluid for suspending proppants in a hydraulic fracture of a subterranean formation, the fluid consisting essentially of or consisting of a carrier fluid; a plurality of comprising one or more primary stems from which a plurality of primary barbs extend; and a plurality of proppants.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method of suspending proppants in a hydraulic fracture of a subterranean formation, the method comprising:
a. hydraulically fracturing the subterranean formation to form fractures in the formation;
b. during and/or after hydraulically fracturing the subterranean formation, introducing proppants into the fractures;
c. during and/or after hydraulically fracturing the subterranean formation, introducing a plurality of junction-structured materials into the fractures, wherein the materials comprise one or more primary stems from which a plurality of primary barbs extend; and
d. collecting or settling the proppants upon the junction-structured materials as the junction-structured materials contact opposing walls of the fractures thereby inhibiting or preventing the proppants from settling by gravity.

2. The method of claim 1 wherein the primary barbs comprise a plurality of secondary barbs or a plurality of barbules extending angularly therefrom.

3. The method of claim 2 wherein the secondary barbs and the barbules are straight or wavy.

4. The method of claim 1 wherein the plurality of junction-structured materials is a plurality of feathers.

5. The method of claim 1 wherein the junction-structured materials comprise a man-made material in a shape selected from the group consisting of a feather, a comb, or a strand of eyelashes.

6. The method of claim 1 wherein the junction-structured materials are a made of a man-made material selected from the group consisting of cotton, wool, silk, fiberglass, polyester, polyurethane, aramid, acrylic, nylon, polyethylene, polypropylene, polyamide, a polycarbonate, a polyvinyl alcohol, polyactic acid, polyglycolic acid, cellulose, polylactide, polyethylene terephthalate, rayon, synthetic fibers, metal, metal oxide, stainless steel and combinations thereof.

7. The method of claim 1 where introducing the junction-structured materials into the fractures comprises using a carrier fluid, in which a proportion of the junction-structured materials in the carrier fluid ranges from about 0.1 pptg to about 200 pptg.

8. The method of claim 1 where the fractures each have at least two opposing fracture walls across a gap and where the junction-structured materials singly have at least one dimension that spans the gap between the opposing fracture walls or where multiple materials interconnected with one another spans the gap between the opposing fracture walls.

9. The method of claim 1 wherein the junction-structured materials have:
a. an average length of from about 0.1 inch to about 20 inches (about 0.25 to about 51 cm);
b. an average width of from about 0.05 inch to about 8 inch (about 1.3 mm to about 20 cm); and
c. an average thickness of from about 0.002 inch to about 0.2 inch (about 0.05 mm to about 5 mm).

10. The method of claim 1 further comprising the step of closing the fractures against the proppants.

11. A fluid for suspending proppants in a hydraulic fracture of a subterranean formation, the fluid comprising:
a. a carrier fluid;
b. a plurality of junction-structured materials comprising one or more primary stems from which a plurality of primary barbs extend; and
c. a plurality of proppants.

12. The fluid of claim 11 wherein the primary barbs comprise a plurality of secondary barbs or a plurality of barbules extending angularly therefrom.

13. The fluid of claim 12 wherein the secondary barbs and the barbules are straight or wavy.

14. The fluid of claim 11 wherein the plurality of junction-structured materials is a plurality of feathers.

15. The fluid of claim 11 wherein the junction-structured materials comprise a man-made material in a shape selected from the group consisting of a feather, a comb, or a strand of eyelashes.

16. The fluid of claim 11 wherein the junction-structured materials are a made of a man-made material selected from the group consisting of cotton, wool, silk, fiberglass, polyester, polyurethane, aramid, acrylic, nylon, polyethylene, polypropylene, polyamide, a polycarbonate, a polyvinyl alcohol, polyactic acid, polyglycolic acid, cellulose, polylactide, polyethylene terephthalate, rayon, synthetic fibers, metal, metal oxide, stainless steel and combinations thereof.

17. The fluid of claim 11 wherein a proportion of the junction-structured materials in the carrier fluid ranges from about 0.1 pptg to about 200 pptg.

18. The fluid of claim 11 wherein the junction-structured materials have:
a. an average length of from about 0.1 inch to about 20 inches (about 0.25 to about 51 cm);
b. an average width of from about 0.05 inch to about 8 inch (about 1.3 mm to about 20 cm); and
c. an average thickness of from about 0.002 inch to about 0.2 inch (about 0.05 mm to about 5 mm).
